(19) United States
(12) Patent Application Publication
(10) Pub. No.: US 2011/0264473 A1
(43) Pub. Date: Oct. 27, 2011

(54) SYSTEM AND METHOD FOR PROVIDING RISK MANAGEMENT FOR VARIABLE ANNUITY CONTRACTS

(76) Inventors: Christopher Blair Abreu, Farmington, CT (US); Paul Marc Boisvert, West Hartford, CT (US); Christie Marie Dietrich, Tariffville, CT (US); James A. Kosinski, Avon, CT (US); Ke Lu, Farmington, CT (US); Richard J. Wirth, West Hartford, CT (US)

(21) Appl. No.: 12/967,786

(22) Filed: Dec. 14, 2010

Related U.S. Application Data
(60) Provisional application No. 61/326,844, filed on Apr. 22, 2010.
(60) Provisional application No. 61/405,964, filed on Oct. 22, 2010.

(51) Int. Cl. G06Q 40/00

(52) U.S. Cl. 705/4; 705/36 R

(57) ABSTRACT

A computer system includes an input device. The input device is configured to receive input data for initiating a variable annuity account issued by an insurance company. The input data includes identifying information for the account holder and the amount to be invested in the account. The variable annuity includes a guarantee feature. The computer system also includes a processor, a program memory and a storage device. The processor is operative with program instructions stored in the program memory to allocate the amount invested between two different investment funds. One of the funds includes an equity asset or an equity index asset. The other fund includes a hedging component that is selected to be negatively correlated in terms of asset value changes with the equity asset or equity index asset.

### CROSS-REFERENCE TO RELATED APPLICATIONS

This utility patent application claims the benefit of U.S. provisional patent application Ser. No. 61/326,844, filed Apr. 22, 2010, and also claims the benefit of U.S. provisional patent application Ser. No. 61/405,964, filed Oct. 22, 2010; both provisional patent applications are incorporated herein by reference.

### FIELD

The present invention relates to computer systems, and particularly to computer systems for administering financial products.

### BACKGROUND

An annuity is a type of insurance product. In general terms, in an annuity contract, an insurance company and an owner contract for the owner to make one or more payments to the insurance company. For that consideration, the insurance company makes periodic payments based on the life of an annuitant. By way of example, the insurance company may be obliged to make a payment of a predetermined amount to the owner annually for a predetermined time period. In another example, the insurance company is obliged to make payments of a predetermined amount to the owner annually for the life of the owner.

Annuities may be immediate annuities, in which the stream of payments begins immediately upon purchase of the annuity contract. Annuities may also have a deferral period, such that the stream of payments only begins after expiration of the deferral period. The asset value of an annuity upon the commencement of a stream of payments generally is a significant factor in determining the amount of the payments. The commencement of the stream of payments is sometimes referred to as “annuitization”.

Two common types of annuities are known as fixed annuities and variable annuities (“VA”). Upon annuitization, fixed annuities offer payments of predetermined value, or of sums that increase by a rate of return. Conversely, upon annuitization of a variable annuity, the amount of the periodic payment is determined by the performance during the deferral period of an investment option or options, which may, in part, be selected by the owner upon purchase of the annuity contract.

With a variable annuity, the owner may bear investment risk. The owner typically has a choice of investment options to which he/she can allocate the account into which the purchase payment(s) are directed. These various investment options, or sub-accounts, may include stocks (also referred to as “equities”), bonds, money market, mutual funds and the like.

Since the yield of a variable annuity is dependent on the specific sub-accounts, the risk involved in purchasing a variable annuity is proportional to the risk involved in investing in the underlying sub-accounts. While the owner may be interested in a specific investment option or set of options, he/she may be reluctant to take on the risk involved over a long period. In such a case, the insurance company that offers the VA product may elect to guarantee a certain minimum return on the owner's investment. According to one example of such a guarantee, known as a guaranteed minimum accumulation benefit (GMAB), a specified minimum contract value is guaranteed at a certain date in the future—such as the end of the deferral period—even if the actual investment performance of the contract account/subaccounts is less than the guaranteed amount. Other types of guarantees issued in connection with VA contracts include a guaranteed minimum withdrawal benefit (GMWB) and a guaranteed minimum lifetime withdrawal benefit (GLWB). Under such guarantees, the issuer of the VA contract guarantees the return of a certain percentage (e.g., 120%) of the owner's initial investment in the form of annual withdrawals of a certain percentage per year (e.g., 5%) for a period of years (in the case of a GMWB) or for life (in the case of a GLWB), even if the value of the contract account is depleted or exhausted, if certain conditions are met. Still other types of VA guarantees are described in a commonly-assigned U.S. patent application published as publication no. 2009/0198522 (which is incorporated herein by reference). Issuance of such guarantees typically occurs under riders to the VA contracts.

Another issue that an owner may face is the possibility that future events may cause him/her to have need for the funds invested in the VA account prior to annuitization. To address this issue, it is known for the VA contract to specify that the VA account is subject to partial or total surrender (also referred to as “redemption”) during the deferral period, typically at the current market value of the VA account assets at the time of surrender. However, with the right of surrender or redemption at market value during the deferral period, the owner may again face a potential investment risk, in that the values of the investment options selected by the owner may have declined from the time of the purchase of the contract to the point in time at which the owner wishes to redeem some or all of the account assets.

Issuers of VA contracts may face potential liabilities under guaranteed benefit riders if the investment options selected by the owner perform poorly such that the actual value of the VA account fails to support the guaranteed benefit. VA contract issuers have addressed these potential liabilities with hedging operations and/or by charging fees to owners in consideration for the guarantees. Nevertheless, the potential liabilities under guaranteed benefit riders may present a degree of uncertainty for the VA contract issuer.

### SUMMARY

An apparatus, method, computer system and computer-readable data storage medium are disclosed which include receiving, via an input device, input data for initiating a variable annuity account. The input data specifies the identity of the account holder for the VA account, and a funding amount to be invested by the account holder in the variable annuity account. The variable annuity account includes at least one guarantee feature (such as a guaranteed benefit rider).

The apparatus, method, computer system and computer-readable data storage medium further include allocating the funding amount between a first investment asset and a second investment asset to produce allocation data, where the first investment asset includes at least one equity and/or equity index asset and the second investment asset is selected to negatively correlate in value changes with the equity or equity index asset.

The apparatus, method, computer system and computer-readable data storage medium further include storing the allocation data in a storage device.

The second (negatively correlated) asset may provide a hedge against declines in value of the first asset, thereby providing risk protection for the owner while mitigating risks for the contract issuer relative to one or more guarantees applicable to the VA contract.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a block diagram that illustrates a computer system in which the present invention is applied.

FIGS. 2 and 3 are block diagrams of server computers that are part of the computer system of FIG. 1.

FIG. 4 is a flow chart that illustrates a process that may be performed in accordance with aspects of the invention in the system of FIGS. 1-3.

FIGS. 5 and 6 are screen displays that may be presented in the system of FIG. 1 in connection with the process of FIG. 4.

FIGS. 7-9 graphically illustrate various investment scenarios and simulated investment results for a variable annuity account provided in accordance with aspects of the present invention.

FIG. 10 is a flow chart that illustrates another process that may be performed in accordance with aspects of the invention in the system of FIGS. 1-3.

FIGS. 11-13 are example screen displays that may be provided in the computer system of FIG. 1 in connection with the process of FIG. 10.

FIG. 14 is a flow chart that illustrates a process that may be performed in accordance with aspects of the invention in the system of FIGS. 1-3.

FIGS. 15 and 16 are alternative example screen displays that may be provided in the computer system of FIG. 1 in connection with the process of FIG. 14.

### DETAILED DESCRIPTION

In general, and for the purpose of introducing concepts of embodiments of the present invention, the investment account for a variable annuity contract may be invested in two funds. The first fund may be a conventional investment fund and the second fund may include a hedging component that mitigates risk for the account and tends to rise in value in the event of losses in the first fund.

The second fund may include, in some embodiments, a hedge component that would purchase put options and invest in other derivative investments in a manner designed to result in increases in value of the assets of the second fund when there are decreases in value an equity linked index like the S&P 500. The investments may be made in an essentially passive manner pursuant to an algorithm that may be developed prior to launching the second fund.

In other embodiments, the second fund may include a hedge component that would purchase put options and invest in other derivative investments in a manner designed to result in increases in value of the second fund's investments when there are decreases in the value of a basket of indices that would replicate the aggregate equity exposure of holders of guarantee riders under VA contracts, as modified by data about asset allocation in the first fund by the holders of guarantee riders. The investments may be made in an essentially passive manner pursuant to an algorithm developed prior to the launch of the second fund. The insurance company that issues the VA contracts may provide an independent portfolio manager with objectively derived data (e.g., daily) to support the portfolio manager's management of the second fund, based on the direction of the holders of guarantee riders to provide such information: (i) aggregate changes to shareholders' initial investments relative to the guarantee account; (ii) aggregate asset values of all investments used as the notional value; (iii) returns based style regression of other investments is possible; (iv) cash flow expectations and movements.

In some embodiments, the insurance company may provide to the portfolio manager information about a synthetic liability that simulates the insurance company's liability under guarantee riders that it has issued. The synthetic liability may have been calculated as a closed form solution of a plain vanilla option (put or call), and the information communicated from the insurance company to the portfolio manager may include the following parameters: (A) notional amount; (B) index (i.e., fund allocation); (C) strike price (also referred to as “moneyness”), and (D) term to maturity.

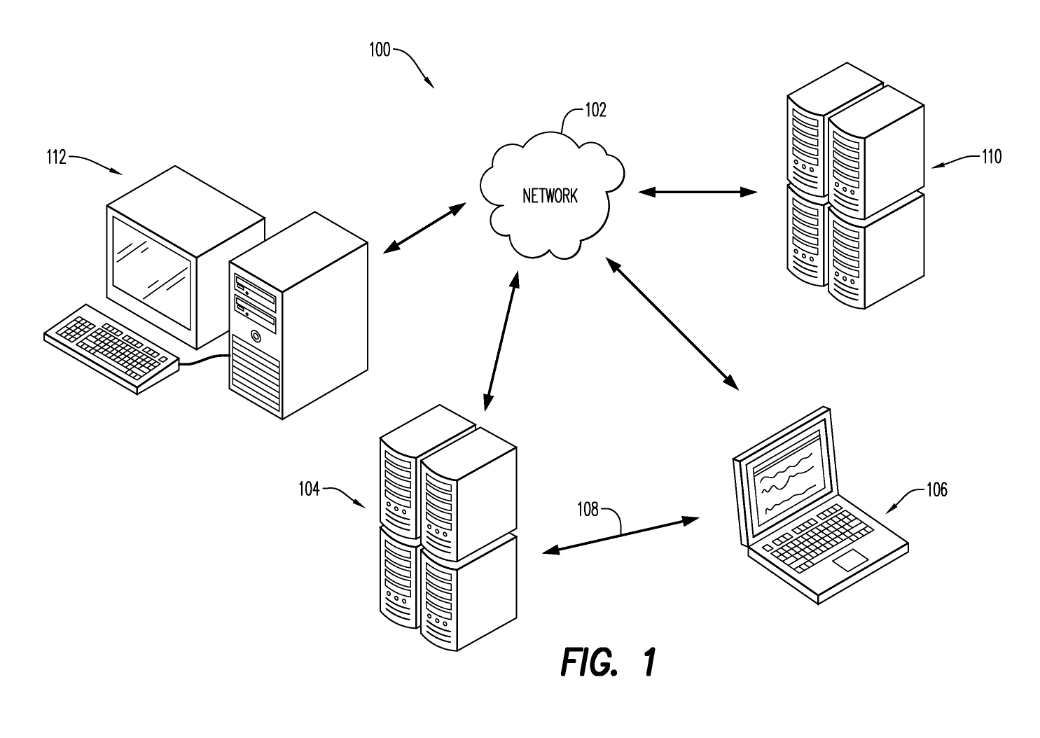

FIG. 1 is a block diagram that illustrates a computer system 100 in which the present invention is applied. At least a portion of the computer system 100 may be operated by an insurance company (not separately shown) that issues VA contracts in accordance with principles of the present invention.

The computer system 100 may include a conventional data communication network 102. The data communication network 102 may, for example, be a combination of one or more private data networks with one or more public data networks such as the Internet.

Further, the computer system 100 may include a contract issuance server computer 104 that is operated by or on behalf the insurance company. The contract issuance server computer 104 is coupled to the data communication network 102, and may receive input and generate information relating to issuance of VA contracts by the insurance company. In doing so, the contract issuance server computer 104 may exchange communications with a customer service user computer 106, which also may be considered to be part of the computer system 100. Although communication between the contract issuance server computer 104 and the customer service user computer 106 is represented as being direct (at 108), in practice such communication may be via the data communication network 102 and for that purpose the customer service user computer 106 may be coupled to the data communication network 102. Although only one customer service user computer 106 is shown in the drawing, in practice the computer system 100 may include a considerable number of such computers.

The computer system 100 may also include a fund balancing server computer 110. The fund balancing server computer 110 is also operated by or on behalf of the insurance company and is coupled to the data communication network 102. The fund balancing server computer 110 may receive from the contract issuance server computer 104 data regarding VA contracts issued by the insurance company and may receive, generate and store data relating to allocation and balancing of assets to be held in the applicable VA accounts, including allocations among equity, fixed income and risk protection funds, etc.

In some embodiments, all of the hardware aspects of the computer system 100 are conventional, but the contract issuance server computer 104 and the fund balancing server computer 110 may be programmed, and may receive input from the customer service user computer 106, such that the computer system 100 is operated in accordance with principles of the present invention, as discussed below. The computer system 100 may also include other components that are not depicted in the drawing, and may perform functions in addition to those explicitly described herein.

FIG. 1 also shows a computer 112 that may be operated by an VA contract owner and that may engage in data communications from time to time with one or more computers operated by the insurance company.

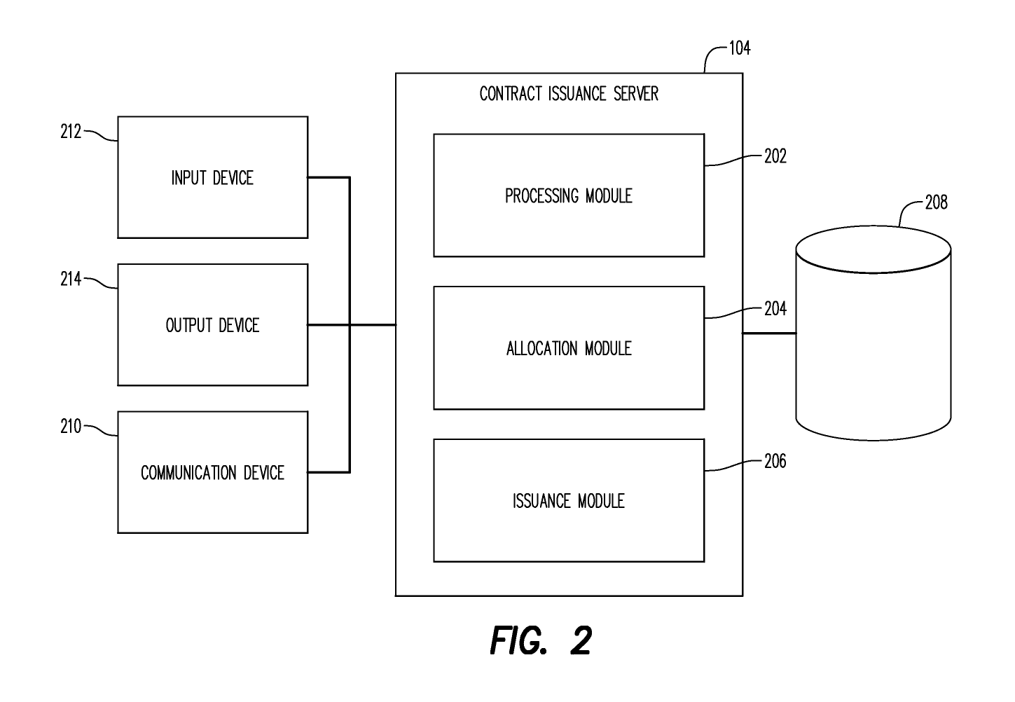

FIG. 2 is a block diagram representation of the contract issuance server computer 104 shown in FIG. 1. The contract issuance server computer 104 may be conventional in terms of its hardware aspects.

As depicted in FIG. 2, the contract issuance server computer 104 includes a processing module 202, which may be constituted by one or more conventional computer processors. The contract issuance server computer 104 further includes an allocation module 204 which generates information concerning the allocation among investment assets of amounts invested in VA accounts issued by the insurance company. The allocation module 204 may be constituted, at least in part, by the processing module 202 in combination with suitable software program instructions. Aspects of the software program instructions for the allocation module 204 will be described below.

The contract issuance server computer 104 further includes a contract issuance module 206 which generates data indicative of issuance of VA contracts. The contract issuance module 206 may also be constituted, at least in part, by the processing module 202 in combination with suitable program instructions. Aspects of the software program instructions for the contract issuance module 206 will also be described below.

The contract issuance server computer 104 further includes one or more storage devices, represented by item 208 in FIG. 2. The storage devices 208 are coupled for data communication with the processing module 202 and may comprise any appropriate information storage device, including combinations of magnetic storage devices (e.g., magnetic tape and hard disk drives), optical storage devices, and/or semiconductor memory devices (such as Random Access Memory (RAM) devices and Read Only Memory (ROM) devices). At least some of these devices may be considered computer-readable storage media, or may include such media. The storage devices 208 may store the above-mentioned software program instructions and/or other program instructions to control the processing module 202 such that the contract issuance server computer 104 provides desired functionality, as described herein. Thus, the storage devices 208 store one or more programs for controlling the processing module 202. The processing module 202 performs instructions of the programs, and thereby operates in accordance with aspects of the present invention. In some embodiments, the programs may include one or more conventional operating systems. The programs may further include application programs such as a conventional data communication program and a conventional database management program. Aspects of the application programs will be described below. Still further, the storage devices 208 may store one or more databases relating to VA contracts issued by the insurance company.

The contract issuance server computer 104 may further include one or more communication devices 210 coupled to the processing module 202. The communication devices 210 may function to facilitate communication with, for example, other devices (such as the customer service user computer 106 and/or the fund balancing server computer 110 shown in FIG. 1). In addition, the contract issuance server computer 104 may include one or more input devices 212 such as a keyboard, a keypad, a mouse or other pointing device, a microphone, knob or a switch, an infra-red (IR) port, a docking station and/or a touch screen. The input device(s) 212 may be coupled to the processing module 202. Still further the contract issuance server computer 104 may include one or more output devices 214, such as a display (e.g., a display screen), a speaker, and/or a printer. The output devices 214 may also be coupled to the processing module 202.

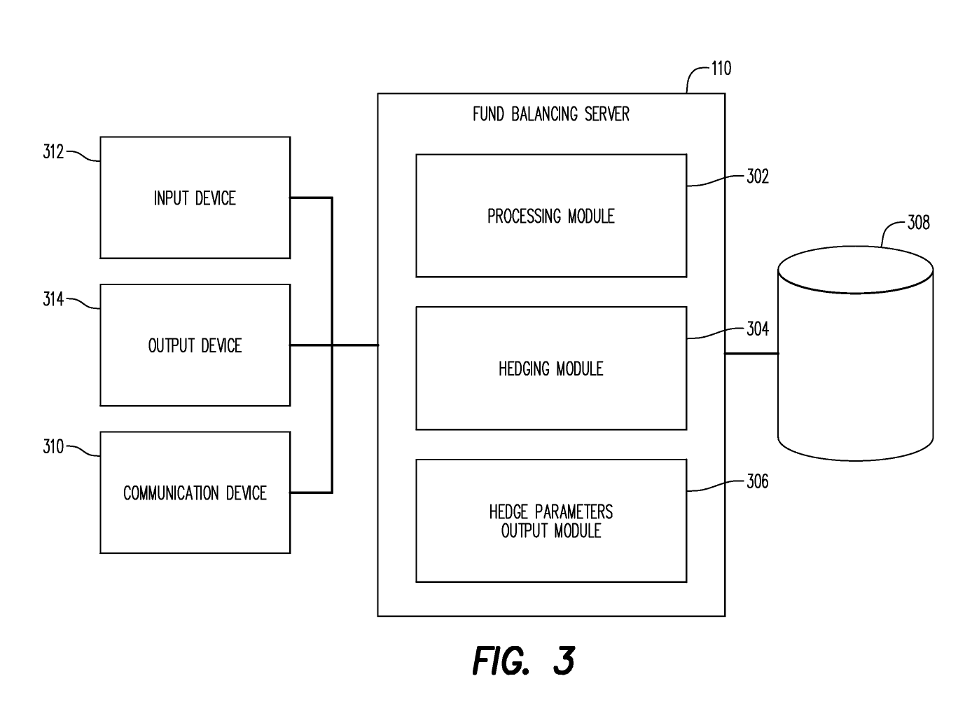

FIG. 3 is a block diagram representation of the fund balancing server computer 110 shown in FIG. 1. The fund balancing server computer 110 may be conventional in terms of its hardware aspects.

As depicted in FIG. 3, the fund balancing server computer 110 includes a processing module 302, which may be constituted by one or more conventional computer processors. The contract administration server computer 110 further includes a hedging module 304 which stores, generates and retrieves information relating to calculations for hedging some or all of the insurance company's liabilities under guaranteed benefit riders (also referred to as guarantee features) under VA contracts issued by the insurance company. (As is discussed below, operations by the hedging module 304 may also hedge the owners' exposure to losses on the equity assets and other assets on their VA accounts, thereby protecting the liquidity of the VA accounts.) The hedging module 304 may be constituted, at least in part, by the processing module 302 in combination with suitable software program instructions. Aspects of the software program instructions for the hedging module 304 will be described below.

The fund balancing server computer 110 further includes a hedge parameter output module 306 which operates to output parameters relevant to execution of a portfolio hedging strategy. These parameters may be output to an independent portfolio manager. As noted above, in some embodiments, the parameters may include the notional, index, strike price and term for a synthetic liability calculated to simulate the insurance company's aggregate liability under guarantee riders to VA contracts. In other embodiments, the insurance company itself may execute the hedging strategy, and in such cases the module 306 may operate as a hedging transaction order generator and may generate and execute orders for hedging transactions to implement one or more hedging strategies in accordance with calculations performed by the hedging module 304. The hedge parameter output module 306 may also be constituted, at least in part, by the processing module 302 in combination with a suitable software program created in accordance with teachings of the present disclosure.

The fund balancing server computer 110 further includes one or more storage devices, represented by item 308 in FIG. 3. The storage devices 308 are coupled for data communication with the processing module 302 and may comprise any appropriate information storage device, including combinations of magnetic storage devices (e.g., magnetic tape and hard disk drives), optical storage devices, and/or semiconductor memory devices (such as Random Access Memory (RAM) devices and Read Only Memory (ROM) devices). At least some of these devices may be considered computer-readable storage media, or may include such media. The storage devices 308 may store the above-mentioned software program instructions and/or other program instructions to control the processing module 302 such that the fund balancing server computer 110 provides desired functionality, as described herein. Thus, the storage devices 308 store one or more programs for controlling the processing module 302. The processing module 302 performs instructions of the programs, and thereby operates in accordance with aspects of the present invention. In some embodiments, the programs may include one or more conventional operating systems. The programs may further include application programs such as a conventional data communication program and a conventional database management program. Aspects of the application programs will be described below.

The fund balancing server computer 110 may further include one or more communication devices 310 coupled to the processing module 302. The communication devices 210 may function to facilitate communication with, for example, other devices (such as the contract issuance server computer 104 shown in FIG. 1). In addition, the fund balancing server computer 110 may include one or more input devices 312 such as a keyboard, a keypad, a mouse or other pointing device, a microphone, knob or a switch, an infra-red (IR) port, a docking station and/or a touch screen. The input device(s) 312 may be coupled to the processing module 302. Still further the fund balancing server computer 110 may include one or more output devices 314, such as a display (e.g., a display screen), a speaker, and/or a printer. The output devices 314 may also be coupled to the processing module 302.

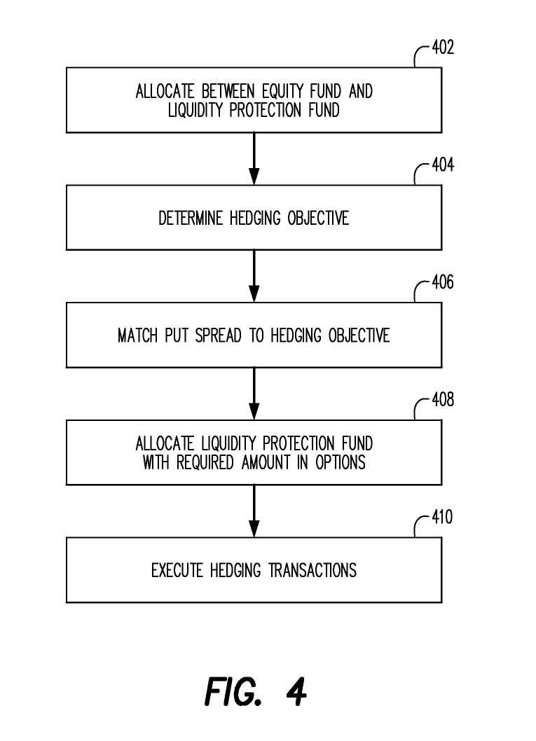

FIG. 4 illustrates in flow-chart form a process that may be performed in accordance with aspects of the present invention in the computer system 100 (e.g., by either or both of the contract issuance server computer 104 and the fund balancing server computer 110).

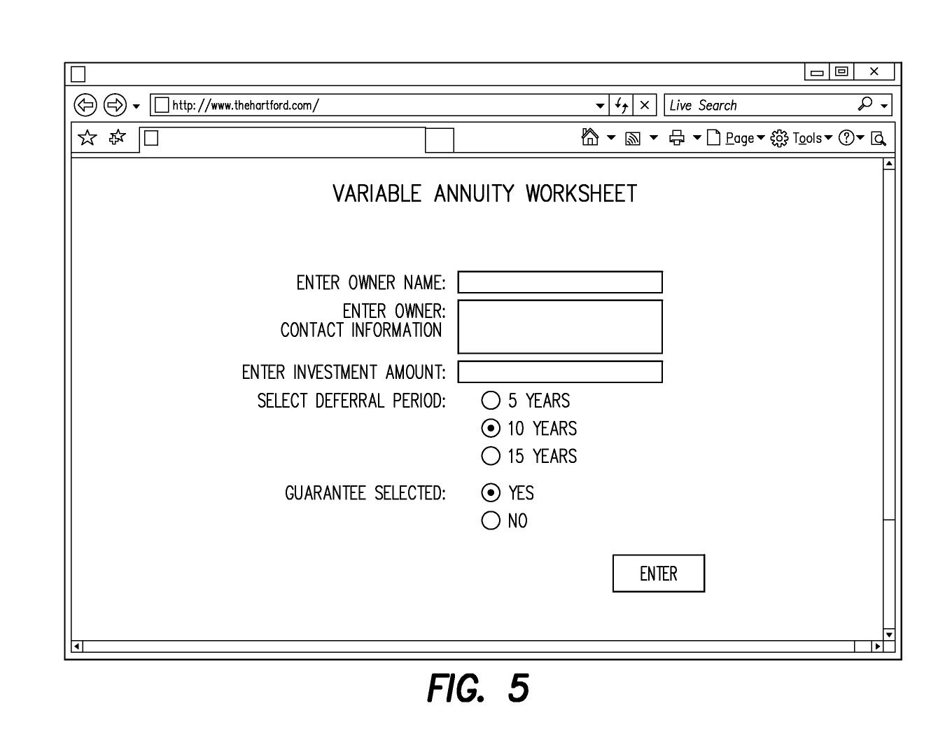

The following process assumes that the insurance company issues VA contracts to owners on an ongoing basis, and that at least some of the contracts carry guaranteed benefit riders (providing one or more of the guarantees of the types described hereinabove and/or in the above-referenced patent publication no. 2009/0198522). In connection with the issuance of each VA contract, an employee of the insurance company may input the following information into the contract issuance server computer 104—the owner's name and mailing address and the amount to be invested in the contract. (FIG. 5 shows an example of one of a number of screen displays that may be provided to the insurance company employee by the contract issuance server computer 104 to allow the entry of information to occur.)

Other information may also be input into the contract issuance server computer 104 by the insurance company employee, such as the nature and particulars of the guaranteed benefit rider. It may be a condition of issuance of the guaranteed benefit rider that a portion of the funds invested in the VA contract be allocated in a risk protection fund that may be operated by or on behalf of the insurance company (or by an independent portfolio manager retained to manage the risk protection fund). Other information input concerning the owner may include, for example, his/her date of birth, contact information in addition to mailing address, Social Security number, etc. Other information customarily needed for issuing a VA contract may also be input, including for example the length of the deferral period.

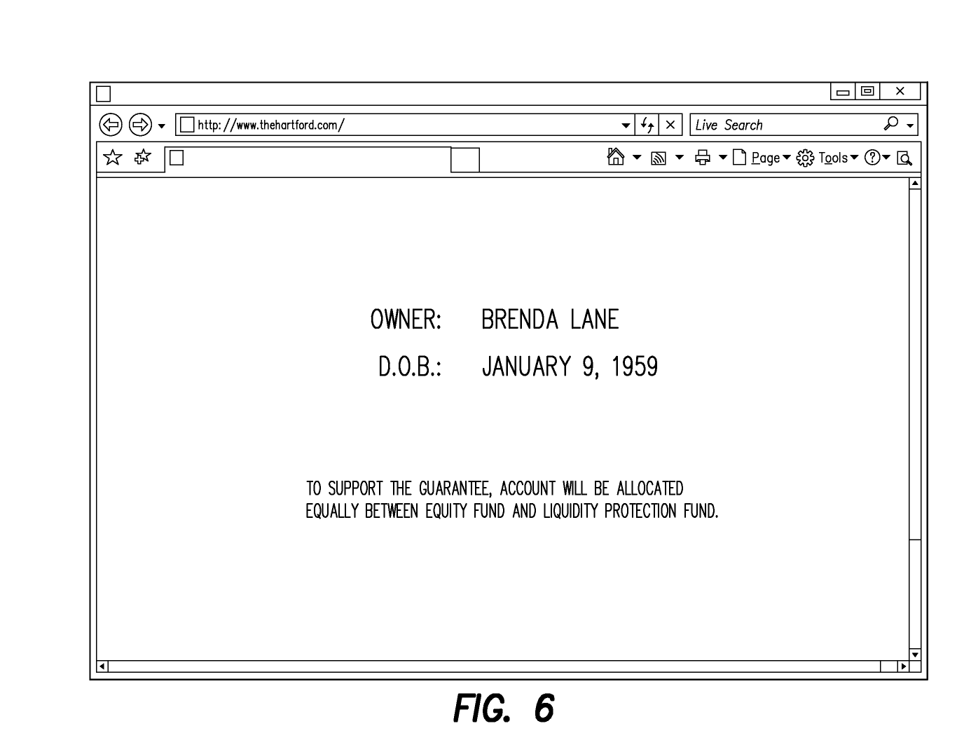

At 402 in FIG. 4, the funds invested in the VA contract are allocated between the risk protection fund and an investment fund that is largely or completely invested in equity assets (including common stocks and/or one or more equity index products). The latter fund may hereinafter be referred to as the “equity fund” (although it may include a proportion of fixed income investments). Allocation of a portion of the VA account to the risk protection account may be required by the contract issuance server computer 104 in at least some cases where the owner elects to purchase a guarantee rider for the VA contract. (This is reflected in the screen display shown in FIG. 6, which may be provided by the contract issuance server computer 104.)

The risk protection fund may be composed of several components including a hedging component, an equity component, a fixed income fund component and a treasuries component. In some embodiments, the hedging component may be invested primarily in options, e.g., in a put spread strategy as described in more detail below, and/or in other derivatives acquired for the purpose of executing a hedging strategy. The equity component of the risk protection fund may be managed so as to track the performance of an equity linked index like the S&P 500. The fixed income fund component may be managed to track a well-known bond fund index such as the Barclays Capital Aggregate Bond Index. The treasuries component may hold U.S. Treasury debt issues.

In one embodiment, the allocation of the VA contract account between the risk protection fund and the equity fund may be 50/50.

In one embodiment, the target allocation ranges for investment assets held in the risk protection fund may be as follows:
Hedging component: 20-60%.
Equity component: 0-40%.
Fixed income fund component: 20-60%.
Treasuries component: 0-20%.

Referring again to FIG. 4, block 404 represents a determination (by the contract issuance server computer 104 and/or the fund balancing server computer 110) as to a hedging objective to be achieved by acquisition of suitable derivatives in the hedging component of the risk protection fund. In some embodiments, the investments in the hedging component may be adjusted daily and may be aimed at matching the “delta”, the “vega” and/or the “rho” of the derivatives in the hedging component with the delta, vega and/or rho of a “synthetic liability” that reflects an estimated liability of the insurance company under guarantees issued in a group of VA contracts that it has issued. The synthetic liability may be derived from the estimated liability under the guarantees, which may in turn be calculated in accordance with known practices. According to alternative embodiments of the invention, the synthetic liability may be calculated as a closed form solution or in open form. In the latter case, the known practices may include generating a model to project insurance cash flows, Monte Carlo simulations of risk neutral scenarios, and fair value estimates of the liability and sensitivities of the liability “Greeks” and “Cross-Greeks”. (As is well known to those who are skilled in the arts, “Greeks” are also referred to as “risk sensitivities” or “risk measures” and are indicative of the sensitivities of the value of an asset or liability to changes in underlying parameters, such as the value of an underlying asset or assets, market volatility, interest rates, etc.)

The synthetic liability may also be modeled as a vanilla option portfolio of puts at an in-the-money strike price. The strike price may depend on the guarantee level as well as on the underlying charges deducted from the VA holders' account value. The delta of the vanilla option portfolio (e.g., puts) may be calculated, again using Monte Carlo simulation, or using a closed end solution based on the well-known Black-Scholes formula. The put may be based on one or more indices and/or a synthetic index that is matched by regression calculations to the investments in the equity fund. Replication of this synthetic hedging targets rebalancing algorithm will result in gains when underlying equity based mutual funds fall in value and losses when underlying equity based mutual funds increase in value.

According to some embodiments, the contract issuance server computer 104 and/or the fund balancing server computer 110 may determine a hedging strategy that matches a target delta. The target delta may be calculated according to the following formula:

Target Delta=((Total Asset Value)/(Index Level))*(Per Unit Delta of a Synthetic Liability)

For this formula, the Synthetic Liability is modeled with a plain vanilla in-the-money put, as described above. The Strike Price is the strike price for the n-year put, determined on the basis of Monte Carlo simulations such that the resulting hedging objective results in eliminating 50% to 80% of the insurance company's risk with respect to the guarantees for the pool of VA contract accounts.

The exact values determined for the Notional, the Strike Price, the Index and the Term to Maturity may represent a trade-off between providing an adequate degree of hedging of the insurance company's risk versus providing a suitable opportunity for the owners to participate in any rise in equity market prices.

To achieve the hedging objective, for example, puts or put spreads may be determined with a delta that matches the target delta (block 406, FIG. 4). (Those who are skilled in the art will recognize that the put spread referred to above may consist of a long put and a short put on an equity linked index. The index may be, for example, an equity index such as the S&P 500 or a combination of indices or a synthetic index that is regression-matched.) Such a spread will provide substantial, though not complete, protection against significant declines in the equity markets, and would be more affordable than a put alone or at a longer maturity.

In other embodiments of the invention, more complete or less complete hedging strategies may be employed, and the hedging component of the risk protection fund may be deployed accordingly. For example, calls, call spreads, futures, swaps and/or other derivatives may be employed in addition to or instead of puts and/or put spreads.

To provide just one, more specific, example allocation of the hedging component of the risk protection fund, the hedging component may be, or may substantially be, constituted by a 90/70 5-year put spread on an equity linked index. That is, the put spread may be formed of a long put with a strike price at 90% of the index price, and a short put with a strike price at 70% of the index price. Such a put spread may be referred to as a 20% put spread because of the 20% (of index price) difference between the long and short strike prices. Many other allocations of the hedging component are possible consistent with the teachings of this disclosure.

In addition to or instead of delta matching, as described above, any one or more, or all, other “Greeks” and/or “Cross Greeks” of the synthetic liability may be matched by the derivatives acquired for the hedging component.

In some embodiments, the hedging transactions may have the effect of reducing the insurance company's estimated liability for the guarantees by 50% to 80%.

In typical cases, the portion of the risk protection fund that is allocated to the hedging component may be as high as 30%—such that the portion of the entire VA account allocated to hedging assets may be about 15%.

In some embodiments, the synthetic liability is calculated daily and the desired Greek-matching hedging transactions are performed daily, such that the derivatives are rolled over and the risk protection fund is rebalanced each day. As indicated at 408 in FIG. 4, the necessary funds are allocated to the hedging component to meet the hedging objective and the balance of the risk protection fund is allocated among the other components thereof. For example, apart from the hedging component, the target proportion between the equity and fixed income components of the risk protection fund may be 1:2.

The daily rolling/rebalancing of the derivatives may provide for a fair net asset value among owners who make their investments in the risk protection fund at different times.

At 410 in FIG. 4, the hedging transactions as determined at 406 are executed (along with any other transactions required for rebalancing the risk protection fund).

In some embodiments, the allocations between the equity fund and risk protection fund may be rebalanced periodically (say, monthly or quarterly) back to a 50/50 allocation. In this way, the owner may be able to participate in, capture and protect rises in the equity market.

According to aspects of the present invention, a half or more of the VA account is allocated to equity investments, thereby according the owner with an opportunity to participate in positive movements in the equity market. However, other holdings in the VA account are allocated to assets that may change in value in a manner that is negatively correlated with changes in value in the equity assets in the VA account. Consequently, the owner may enjoy substantial protection against declines in the equities markets, and may suffer little loss in liquidity in the event of market declines. At the same time, the presence of the “contra” assets in the VA account may mitigate the insurance company's risk relative to any guarantee feature, and may allow the insurance company to reduce fees charged for guarantees in connection with VA account. The resulting increase in stability of the VA investment may be a favorable feature that outweighs the decrease in upside potential that arises from the allocation to hedging assets.

In some embodiments, one or more of the Monte Carlo simulations may reflect actual current and/or historical experience of the insurance company with respect to the behaviors of policy holders in making redemptions of VA accounts and/or making additional investments therein and/or in qualifying for payments under guaranteed benefit riders.

In some embodiments, the hedging objective may be based on the delta and/or other Greeks of the actual liability of the insurance company under the guarantees rather than the synthetic liability as modeled by an n-year vanilla put (or another model).

U.S. published patent application no. 2009/0030852 (commonly assigned herewith and incorporated by reference herein) discloses techniques whereby the behavior risks and market risks relative to issuance of VA contract guarantees are separated from each other and are separately assigned and/or assumed. The synthetic liability to be (fully or partially) hedged according to the teachings hereof may accordingly be based on either or both of the market risks and the behavior risks.

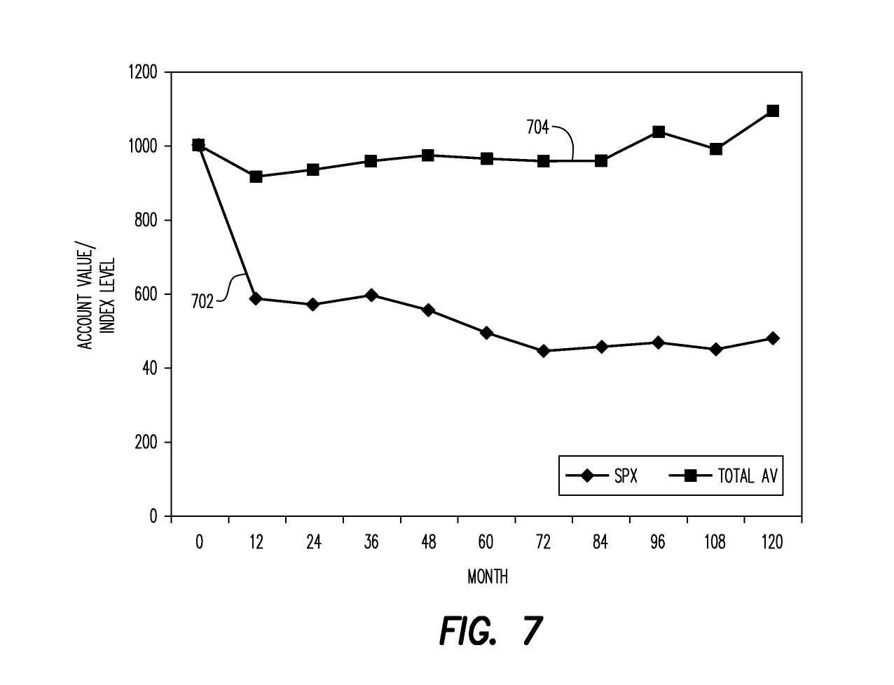

FIGS. 7-9 graphically illustrate various investment scenarios and simulated investment results for a variable annuity account provided in accordance with aspects of the present invention.

FIG. 7 illustrates a scenario where the equities market, represented by the S&P 500 Index and illustrated by trace 702, performs poorly over the 10-year deferral period. Because of the hedging component of the risk protection fund, the actual value (AV) of the variable annuity account is essentially maintained in value, as illustrated by trace 704.

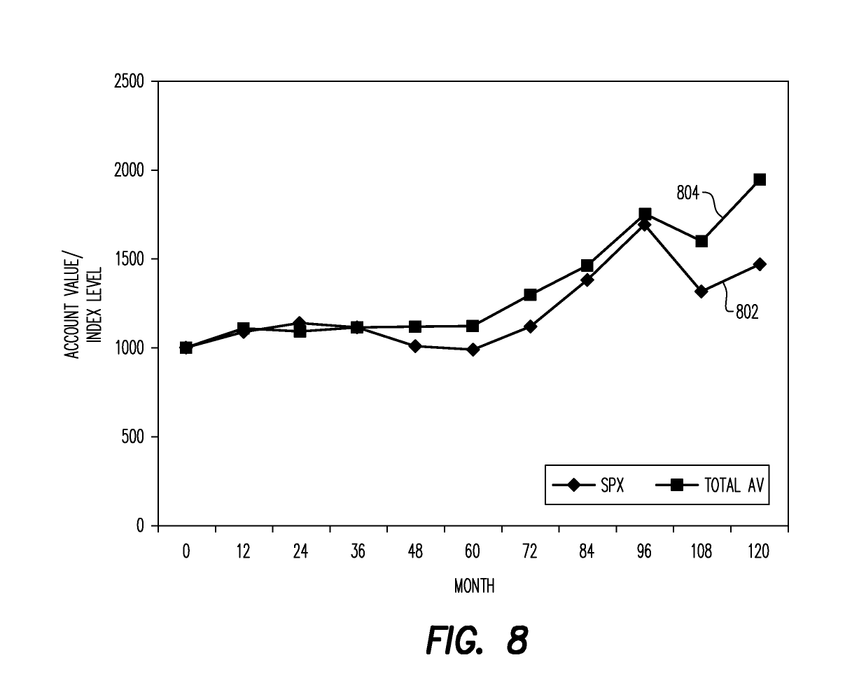

FIG. 8 shows another scenario, in which the equities market (trace 802) increases after a prolonged period without substantial movement, but then suffers a decline. In this simulation, the account AV (trace 804) generally tracks the equities market up to the peak, and then holds its value better than the equities index in the face of the sharp decline.

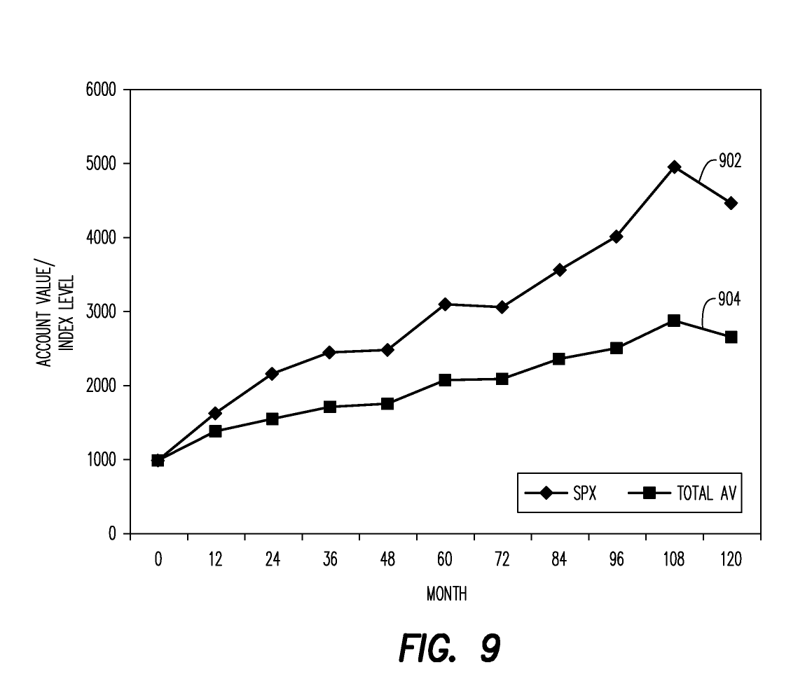

FIG. 9 shows yet another scenario. In this case, the equities market (trace 902) shows outstanding performance through almost all of the deferral period. The account value (trace 904) also performs well, but significantly lags the strong gains made by equities. This scenario illustrates the possible price to be paid for the account value stability provided by the hedging portion of the account asset allocation—some of the upside potential is foregone in the interest of realizing stability and risk protection.

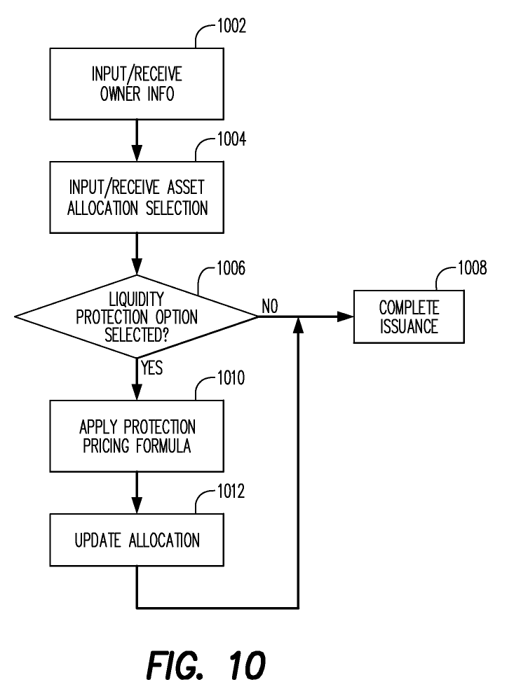

FIG. 10 illustrates in flow-chart form a process that may be performed in accordance with aspects of the present invention in the computer system 100. As will be seen, key aspects of the process of FIG. 10 are performed by the contract issuance server computer 104. In general the computer system 100 may be somewhat modified in order to be adapted to performing the process of FIG. 10.

At 1002 in FIG. 10, a customer service employee of the insurance company inputs, via the customer service user computer 106, and the contract issuance server computer 104 receives, data indicative of the individual (i.e., the prospective owner) who is to be the holder of a VA contract to be issued by the insurance company. The information about the owner may include, for example, his/her name, date of birth, mailing address and other contact information, Social Security number, etc. Other information customarily needed for issuing a VA contract may also be input and received in the computer system 100, including for example the amount to be invested in the VA contract, and the length of the deferral period.

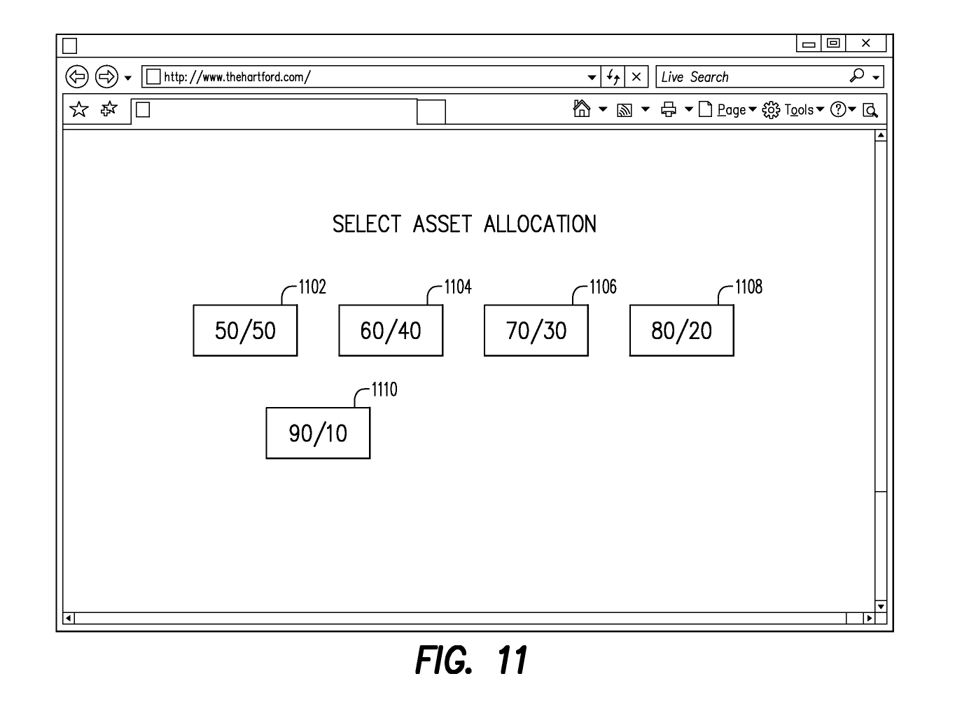

As part of the process for entering the data needed for issuance of the VA contract, the contract issuance server computer 104 may download to the customer service user computer 106, and the customer service user computer 106 may display, a screen display like that shown in FIG. 11. The purpose of the screen display of FIG. 11 is to prompt the user (customer service representative) to input a selection of the allocation of assets in the VA account between equity investments (stocks) and fixed income investments (bonds). Presumably, the customer service representative will inquire of the owner what allocation the owner desires and will provide input accordingly. It will be noted that the screen display of FIG. 11 includes virtual buttons 1102, 1104, 1106, 1108 and 1110, any one of which may be actuating by “clicking” with a mouse/cursor in a conventional manner. Actuation of button 1102 indicates that the allocation is to be 50% stocks and 50% bonds. Actuation of button 1104 indicates that the allocation is to be 60% stocks and 40% bonds. Actuation of button 1106 indicates that the allocation is to be 70% stocks and 30% bonds. Actuation of button 1108 indicates that the allocation is to be 80% stocks and 20% bonds. Actuation of button 1110 indicates that the allocation is to be 90% stocks and 10% bonds.

(It should be understood that the set of allocation options presented in the screen display is only an example, and that other allocation options, and/or a different set of allocation options, may be provided.)

Referring again to FIG. 10, block 1004 represents inputting and receiving data to indicate selection of the asset allocation for the VA account. This may occur, for example, by the customer service representative actuating one of the buttons shown in FIG. 11. Data indicative of the asset allocation that is selected may be stored, for example, in a component of the computer system 100 that performs VA contract administration.

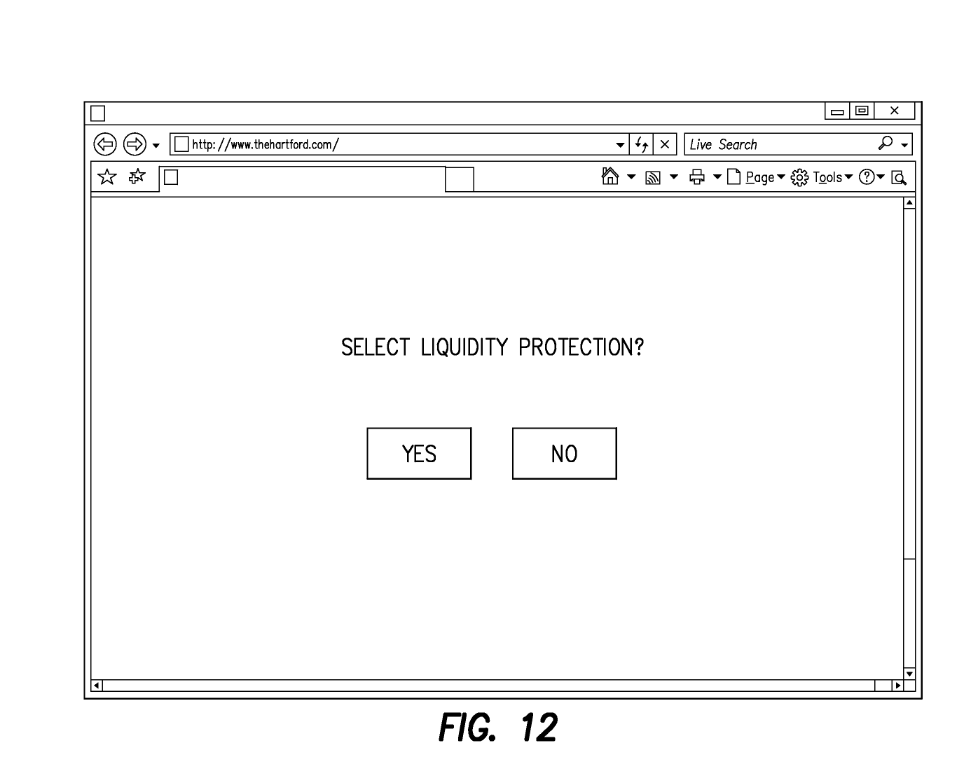

FIG. 12 shows a further screen display that may be downloaded from the contract issuance server computer 104 to the customer service user computer 106 and displayed by the customer service user computer 106. The purpose of the screen display of FIG. 12 is to prompt input as to whether or not the owner is selecting a risk protection feature for his/her VA account. The risk protection feature is provided in accordance with an aspect of the present invention.

According to the risk protection feature, a portion of the VA account is allocated to a risk protection feature subaccount, along with allocations to the conventional equities and fixed income subaccounts. The value of the risk protection feature subaccount is to be determined, on a daily basis during the deferral period, according to a risk protection feature payout formula. The payout formula is designed to be negatively correlated with changes in value in either or both of the equity and fixed income subaccounts. The risk protection feature may be regarded as a synthetic asset, with its payout value during the deferral period representing a contractual guarantee by the insurance company that tends to support the daily redeemable value of the owner's VA account. This guarantee may be provided by the insurance company as a supplement to one or more conventional guarantees, such as that provided in connection with a guaranteed minimum accumulation benefit. The insurance company may engage in suitable hedging operations to mitigate the risks it incurs in offering the risk protection feature. Design and execution of such hedging operations is within the abilities of those who are skilled in the art.

The valuation of the payout formula may be derived from what is essentially an n-year put option (over the balance of the deferral period) on a synthetically created underlying basket of periodically rebalanced known market indices. The indices in question may include, for example, the S&P 500, NASDAQ and/or EAFE. The synthetically created basket of indices may be referred to herein as the “Index Basket Fund”. The risk protection feature payout formula may be designed to offset both positive and negative performance of the underlying Index Basket Fund. The value of the payout formula, in a preferred embodiment, cannot be less than zero. The Index Basket Fund itself does not represent a portion of the owner's VA account, in this embodiment. In some embodiments, the Index Basket Fund may include one or more bond indices.

Construction of the Index Basket Fund may be based on a regression process that identifies a portfolio that best replicates mutual fund investments selected by the owner. The particular asset allocation selected by the owner may be mapped to a specific Index Basket Fund model that is appropriate for the selected asset allocation. The Index Basket Fund may be rolled forward daily for index performance with adjustments for transactions (additional purchases and/or redemptions) against the VA account.

Each index in the Index Basket Fund may be projected using a stochastic process for equity prices for each model index within the basket. An example formula for this process is as follows:

dS(t)=S(t)[rₜ−qₜ]dt+S(t)σₜdW(t)

where:
S(t)=Stock Price Function
rₜ=The instantaneous risk free rate, which may vary through time and may be deterministic or stochastic
qₜ=The dividend yield on the market index that will be projected, which may vary through time and may be deterministic or stochastic
dₜ=time
σₜ=The volatility on the market index that will be projected, which may vary through time and may be deterministic or stochastic
W(t)=Wiener process

In the event that multiple indices in the index basket fund are projected, the Wiener processes for the different indices may be correlated, and, to the extent that the risk free rate, dividend yield, and volatility are stochastic processes, these stochastic processes may be correlated with the index stochastic processes.

The put option valuation may assume arbitrage-freeness. That is, the averaged PV using Monte Carlo simulation for the (put) option payoff may equal the fair market price at issue of the individual risk protection feature and on every future valuation date for the individual risk protection feature.

In some embodiments, the current value of the risk protection feature subaccount may be backed by assets held in a special account by the insurance company.

Referring again to FIG. 10, at decision block 1006 the contract issuance server computer 104 determines whether input from the customer service user computer 106 indicates that risk protection is selected. If not, then block 1008 follows decision block 1006. At block 1008, the contract issuance server computer 104 issues the VA contract based on the asset allocation made at 1004 and without making any allocation to a risk protection feature subaccount.

Considering again decision block 1006, if it is determined that risk protection is selected, then the process advances from decision block 1006 to block 1010. At 1010, the contract issuance server computer 104 applies a suitable process to arrive at the amount to be allocated to the risk protection feature subaccount. For example, the pricing may be derived from an evaluation of the risk protection feature payout formula at the time of issuance. It typically may be the case that the pricing/allocation of account value to the risk protection feature may be based at least in part on the allocation of assets between equity and fixed income subaccounts, as elected by the owner at 1004 (FIG. 10).

In some embodiments, the initial pricing determination and/or evaluation of the payout formula during the deferral period may be in accordance with principles of the Black-Scholes model.

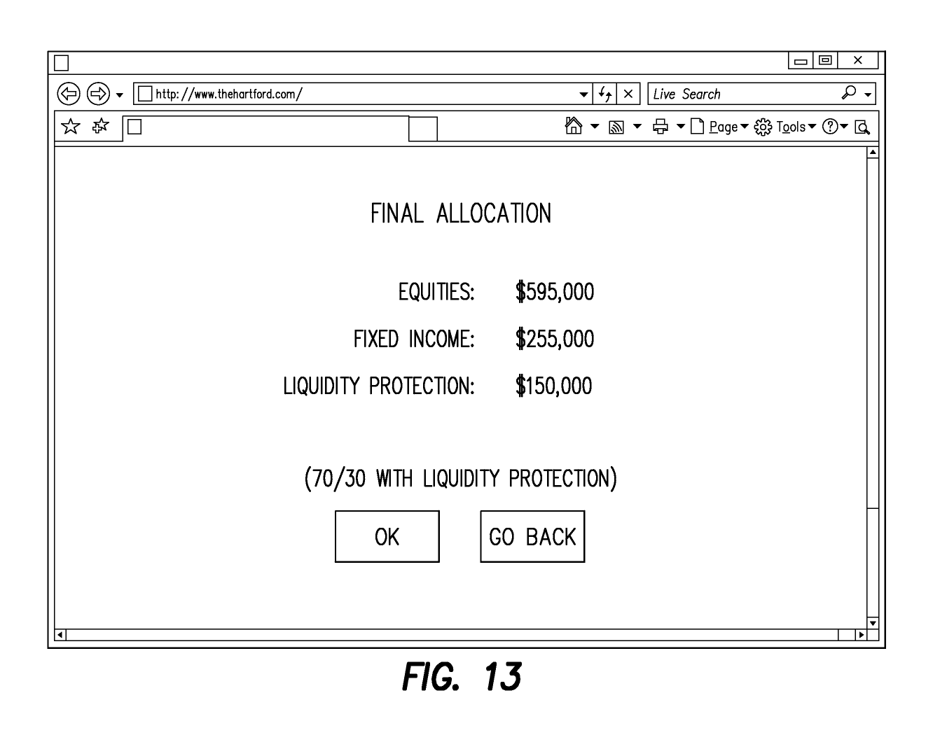

An example of asset allocation in accordance with an embodiment of the invention is illustrated in FIG. 13, which is a screen display that may be downloaded from the contract issuance server computer 104 to the customer service user computer 106 and displayed by the customer service user computer 106. For the example shown in FIG. 13, it is assumed that the amount to be invested in the VA contract is $1,000,000, that the owner has selected a 70/30 stock/bond allocation and also has elected risk protection. It is also assumed that the contract issuance server computer 104 has indicated that the amount to be allocated to the risk protection fund subaccount is $150,000. Consequently, the entire asset allocation is stocks—$595,000; bonds—$255,000; and risk protection—$150,000. If the customer service representative confirms this is correct, then the process of FIG. 10 advances from block 1010 to block 1012. At 1012, the contract issuance server computer 104 updates the asset allocation to include the indicated allocation of account value to the risk protection feature subaccount, and then the contract issuance module 206 of the contract issuance server computer 104 issues the VA contract (block 1008, FIG. 10) with the updated allocation.

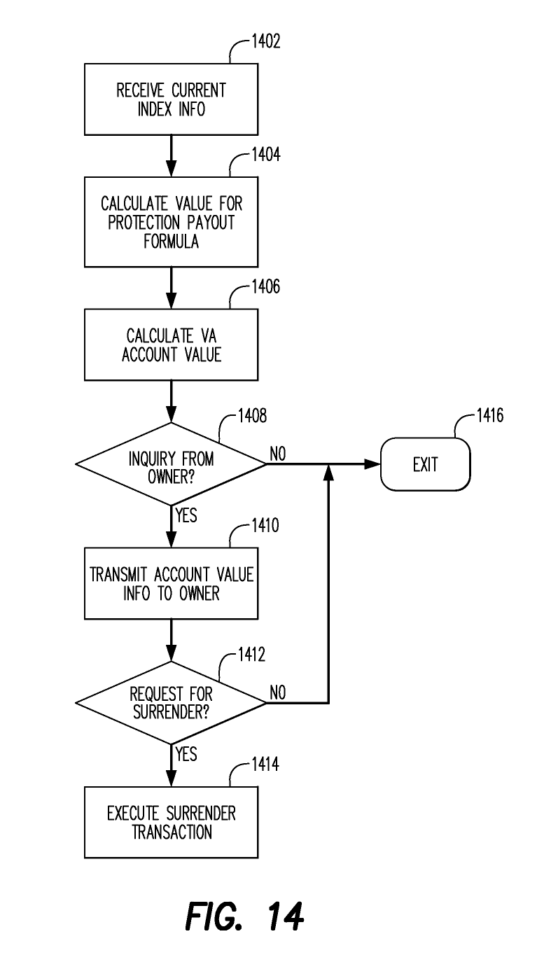

FIG. 14 is a flow chart that illustrates a process that may be performed in accordance with aspects of the invention in the computer system 100 during the deferral period of a VA contract.

At 1402 in FIG. 14, the computer system 100 receives from various data sources (not shown) information regarding the current value(s) of indices that make up the Index Basket Fund.

At 1404, the computer system 100 uses the index information received at 1402 to calculate a current value for the risk protection feature payout formula that is applicable to a particular VA account. (The same formula may also be applicable to a number of other VA accounts, including accounts purchased in the same syndication period as the VA account in question.)

At 1406, the computer system 100 calculates the total current (daily) value for the VA account, based on the evaluation of the risk protection feature payout formula, and also based on the market values of the equity and fixed income subaccounts.

At decision block 1408, the computer system 100 determines whether it has received an inquiry from the owner (i.e., the account holder). Such an inquiry may be received from the owner user computer 112 (FIG. 1). If received, then the inquiry causes the process of FIG. 14 to advance from decision block 1408 to block 1410.

At block 1410, the computer system 100 responds by downloading information about the current value of the VA account to the owner's computer 112.

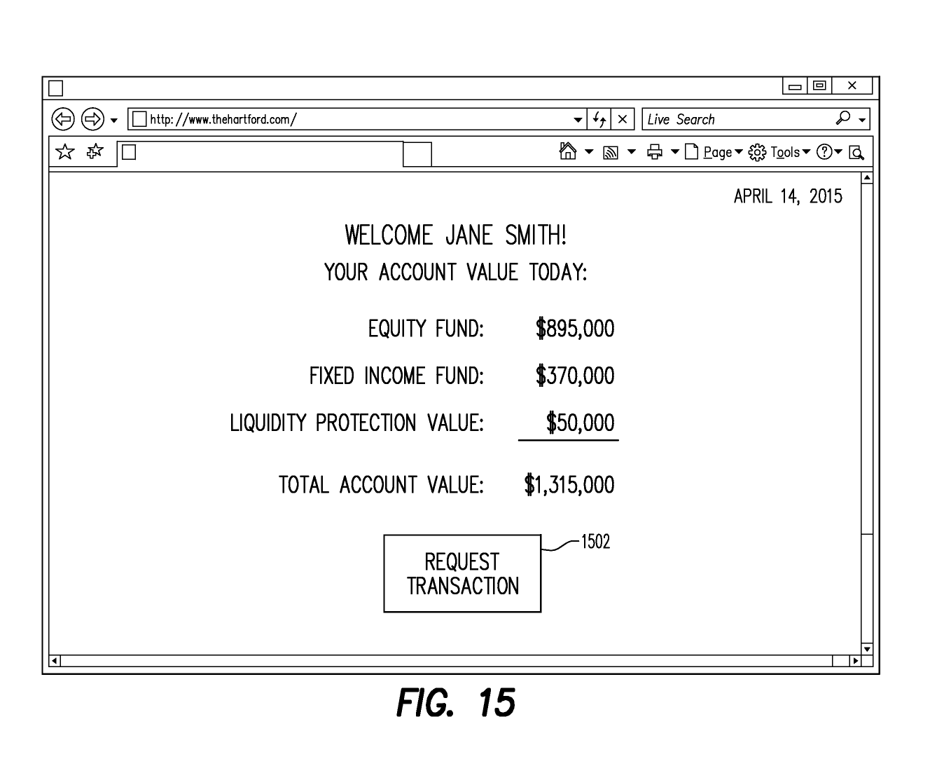

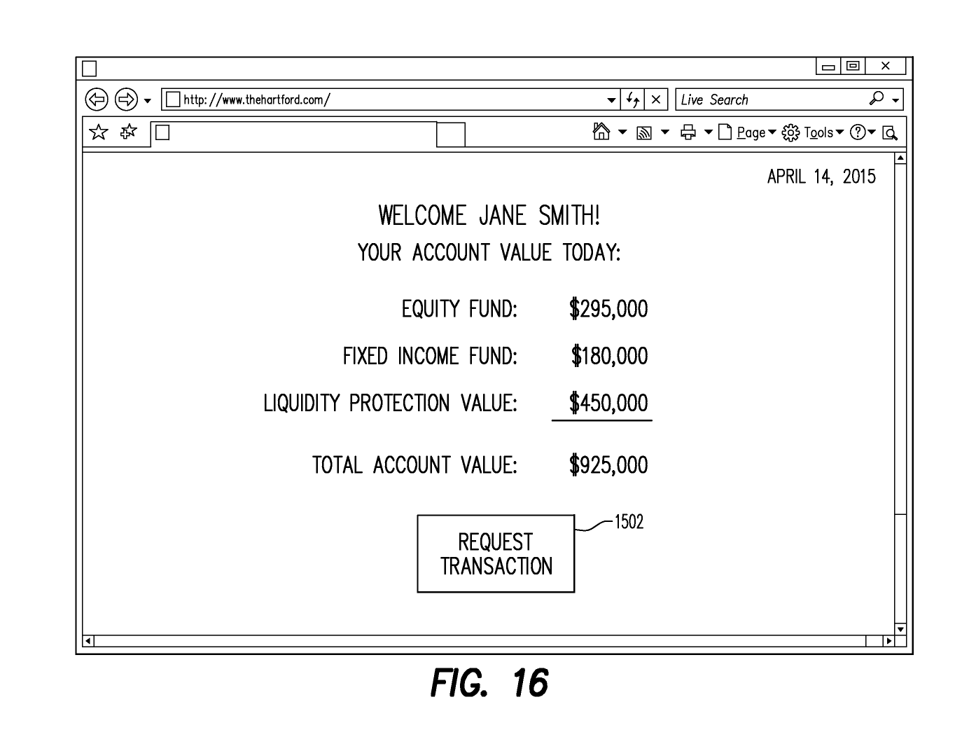

FIGS. 15 and 16 are alternative example screen displays that may be downloaded in connection with block 1410 from the computer system 100 for display on the owner's computer 112, depending on the investment performance of the VA account up to the current point in the deferral period.

FIG. 15 assumes that there has been a favorable investment climate up to this point in the deferral period, and that the equity and fixed income subaccounts have substantially increased in value (as compared with the initial allocation amounts shown in FIG. 13). Because the value of the risk protection feature subaccount is negatively correlated with the other subaccounts, its value has declined, and the VA account as a whole has gained somewhat less than it would have if the VA account had no risk protection.

FIG. 16 assumes that there has been an unfavorable investment climate up to this point in the deferral period. Consequently, both the equity and fixed income subaccounts have suffered significant declines in value (again as compared to the initial values shown in FIG. 13). However, in this type of scenario, the owner receives a substantial advantage and protection of the VA account's liquidity because he/she had elected risk protection. In this example, the value of the risk protection feature subaccount has greatly increased, due to its negative correlation with the other subaccounts, and the total value of the VA account—while somewhat less than the original value—has declined much less than would have been the case if the owner had not elected risk protection. As a result, if the owner wishes or needs to make a partial or complete surrender of the account at this time, he/she will incur only a modest amount of loss rather than the severe loss that would have occurred in the absence of the risk protection feature subaccount.

Referring once more to FIG. 14, block 1410 is followed by a decision block 1412. At decision block 1412, the computer system 100 determines whether the owner has requested a complete or partial surrender of his/her VA account, e.g., by actuating the virtual button indicated at 1502 in FIG. 15 or FIG. 16. If so, the computer system 100 executes the requested surrender transaction, as indicated at 1414 in FIG. 14.

For the sake of completeness relative to FIG. 14, it will be noted that if it is determined at decision block 1408 that no inquiry is received from the owner, then the process exits (block 1416). Similarly, if at decision block 1412 it is determined that there is no request for a surrender transaction, again it is the case that the process exits (block 1416).

In the example VA account illustrated in FIGS. 13 and 15/16, the owner paid for the risk protection feature with an upfront allocation of the original premium to the risk protection feature subaccount. Alternatively, however, the payment for risk protection may be made periodically in installments over the deferral period.

According to some embodiments of the risk protection feature, the VA contract may provide for resetting the risk protection feature during the deferral period, in the event of a significant increase in equity/bond values such that the original protection feature is reduced to, or near to, zero. In other words, to implement the resetting—after a run-up in equity and/or fixed income values—a portion of one or both of the equity and fixed income subaccounts is reallocated to the risk protection feature subaccount to protect the liquidity of (and effectively to lock in) at least a portion of the increased value of the VA account. The resetting may occur automatically or, in alternative embodiments, at the option of the owner.

In some embodiments, the insurance company may offer a guarantee at maturity (e.g., a GMAB) that covers the entire initial value of the VA account, including any amount allocated to the risk protection feature subaccount.

Although the computers 104 and 110 are depicted and described as separate computer resources in the above disclosure, it may alternatively be the case that the functions of those two computers may be combined in a single computer or computer system.

The process descriptions and flow charts contained herein should not be considered to imply a fixed order for performing process steps. Rather, process steps may be performed in any order that is practicable.

As used in the phrase “substantially less than 100%”, the term “substantially less” means 90% or less of the risk related to a liability.

As used herein and in the appended claims, the term “computer” refers to a single computer or to two or more computers in communication with each other and/or operated by a single organization or by two or more organizations that are partly or entirely under common ownership and/or control.

As used herein and in the appended claims, the term “processor” refers to one processor or two or more processors that are in communication with each other.

As used herein and in the appended claims, the term “memory” refers to one, two or more memory and/or data storage devices.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer system for administering variable annuity accounts, the computer system comprising:
an input device configured to receive input data relating to a variable annuity account issued by an insurance company, the input data specifying: an identity of the account holder for the variable annuity account and a funding amount to be invested by the account holder in the variable annuity account, the variable annuity account including at least one guarantee feature;
a processor, in communication with the input device;
program memory in communication with the processor, the program memory storing program instructions for controlling the processor;
a storage device in communication with the processor;
the processor operative with the program instructions to:
allocate the funding amount between a first investment fund and a second investment fund to produce allocation data, the first investment fund including at least one equity and/or equity index asset, the second investment fund including a hedging component, the hedging component selected to negatively correlate in value changes with the at least one equity and/or equity index asset; the hedging component containing one or more derivative assets; the one or more derivative assets designed to hedge at least 50% of the insurance company's liability under the at least one guarantee feature; and
store the allocation data in the data storage device.

2. The computer system of claim 1, wherein the hedging component is deployed so as to hedge substantially less than 100% of the insurance company's liability under the at least one guarantee feature.

3. The computer system of claim 2, wherein the derivative assets include one or more put spreads.

4. The computer system of claim 3, wherein the one or more put spreads include at least one equity index put.

5. The computer system of claim 4, wherein a long side of the put spread is at a strike price of about 90% of an index value and a short side of the put spread is at a strike price of about 70% of the index value.

6. The computer system of claim 1, wherein the funding amount is allocated equally between the first investment fund and the second investment fund.

7. The computer system of claim 6, wherein substantially 30% of the second investment fund is invested in said one or more derivative assets.

8. The computer system of claim 6, wherein the processor is further operative with the program instructions to:
periodically re-balance said allocation between the first and second investment funds to substantially restore a 50-50 allocation between the first and second investment funds.

9. The computer system of claim 8, wherein said re-balancing is performed quarterly.

10. The computer system of claim 8, wherein said re-balancing is performed monthly.

11. The computer system of claim 1, wherein the hedging component is deployed based at least in part on a synthetic liability calculated to simulate the insurance company's liability under the at least one guarantee feature.

12. The computer system of claim 11, wherein the derivative assets contained in the hedging component are deployed to match at least one risk sensitivity of the synthetic liability.

13. The computer system of claim 12, wherein the derivative assets contained in the hedging component are deployed to match at least one of a delta risk sensitivity, a vega risk sensitivity and a rho risk sensitivity of the synthetic liability.

14. The computer system of claim 1, wherein the second investment fund also includes one or more of an equity component, a fixed income component and a U.S. treasuries component.

15. A computer-implemented method for administering a variable annuity account issued by an insurance company, comprising the steps of:
receiving, from an input device, input data relating to the variable annuity account, the input data specifying: an identity of the account holder for the variable annuity account and a funding amount to be invested by the account holder in the variable annuity account, the variable annuity account including at least one guarantee feature;
storing the input data in a data storage device;
allocating the funding amount between a first investment fund and a second investment fund to produce allocation data, the first investment fund including at least one equity and/or equity index asset, the second investment fund including a hedging component, the hedging component selected to negatively correlate in value changes with the at least one equity and/or equity index asset; the hedging component containing one or more derivative assets; the one or more derivative assets designed to hedge at least 50% of the insurance company's liability under the at least one guarantee feature; and
storing the allocation data in the data storage device.

16. The method of claim 15, wherein the hedging component is deployed so as to hedge substantially less than 100% of the insurance company's liability under the at least one guarantee feature.

17. The method of claim 16, wherein the derivative assets include one or more put spreads.

18. The method of claim 17, wherein the one or more put spreads include at least one equity index put.

19. The method of claim 18, wherein a long side of the put spread is at a strike price of about 90% of an index value and a short side of the put spread is at a strike price of about 70% of the index value.

20. The method of claim 15, wherein the funding amount is allocated equally between the first investment fund and the second investment fund.

21. The method of claim 20, wherein substantially 30% of the second investment fund is invested in said one or more derivative assets.

22. The method of claim 20, further comprising:
periodically re-balancing said allocation between the first and second investment funds to substantially restore a 50-50 allocation between the first and second investment funds.

23. The method of claim 22, wherein said re-balancing is performed quarterly.

24. The method of claim 22, wherein said re-balancing is performed monthly.

25. The method of claim 15, wherein the hedging component is deployed based at least in part on a synthetic liability calculated to simulate the insurance company's liability under the at least one guarantee feature.

26. The method of claim 25, wherein the derivative assets contained in the hedging component are deployed to match at least one risk sensitivity of the synthetic liability.

27. The method of claim 26, wherein the derivative assets contained in the hedging component are deployed to match at least one of a delta risk sensitivity, a vega risk sensitivity and a rho risk sensitivity of the synthetic liability.

28. The method of claim 15, wherein the second investment fund also includes one or more of an equity component, a fixed income component and a U.S. treasuries component.

29. A computer system for administering variable annuity accounts, the computer system comprising:
an input device configured to receive input data relating to a variable annuity account issued by an insurance company, the input data specifying: an identity of the account holder for the variable annuity account and a funding amount to be invested by the account holder in the variable annuity account, the variable annuity account including at least one guarantee feature;
a processor, in communication with the input device;
program memory in communication with the processor, the program memory storing program instructions for controlling the processor;
a storage device in communication with the processor;
the processor operative with the program instructions to:
allocate the funding amount between a first investment asset and a second investment asset to produce allocation data, the first investment asset comprising at least one equity and/or equity index asset; the second investment asset selected to negatively correlate in value changes with the at least one equity and/or equity index asset; and
store the allocation data in the data storage device.

30. The computer system of claim 29, wherein the first asset is a first investment fund, and the second asset is a second investment fund, the second investment fund including a hedging component.

31. The computer system of claim 29, wherein the second asset is a risk protection feature; wherein the risk protection feature is associated with a risk protection feature payout formula, said payout formula negatively correlated with a value of said first asset.

32. A computer-implemented method for administering a variable annuity account issued by an insurance company, comprising the steps of:
receiving, from an input device, input data relating to the variable annuity account, the input data specifying: an identity of the account holder for the variable annuity account and a funding amount to be invested by the account holder in the variable annuity account, the variable annuity account including at least one guarantee feature;
storing the input data in a data storage device;
allocating the funding amount between a first investment asset and a second investment asset to produce allocation data, the first investment asset comprising at least one equity and/or equity index asset; the second investment asset selected to negatively correlate in value changes with the at least one equity and/or equity index asset; and
storing the allocation data in the data storage device.

33. The method of claim 32, wherein the first asset is a first investment fund, and the second asset is a second investment fund, the second investment fund including a hedging component.

34. The method of claim 33, wherein the second investment fund also includes a bond index investment component.

35. The method of claim 34, wherein the hedging component includes derivative assets.

36. The method of claim 35, wherein the second investment fund also includes an equity index investment component.

37. The method of claim 32, wherein the second asset is a risk protection feature; wherein the risk protection feature is associated with a risk protection feature payout formula, said payout formula negatively correlated with a value of said first asset.

38. A computer-implemented method for administering a variable annuity account, comprising the steps of:
receiving, from an input device, input data for initiating the variable annuity account, the input data specifying: an identity of an account holder for the variable annuity account; an allocation of assets among a plurality of asset funds; and an allocation of account value to a risk protection feature; wherein the risk protection feature is associated with a risk protection feature payout formula, said payout formula negatively correlated with a composite value of said asset funds;
storing the input data in a data storage device;
initiating the variable annuity account based on the stored input data; and
during a deferral period for the variable annuity account:
calculating a daily redeemable account value for the variable annuity account, the daily redeemable account value based on (a) respective values of the asset funds, and (b) a current evaluation of the risk protection feature payout formula; and
transmitting, to a device operated by the account holder, data indicative of the daily redeemable account value, in response to an inquiry received from the device operated by the account holder.

39. The computer-implemented method of claim 38, further comprising:
calculating the allocation of account value to the risk protection feature based on a risk protection feature pricing formula, wherein the risk protection feature pricing formula is based at least in part on the allocation of assets among the plurality of asset funds.

40. The computer-implemented method of claim 38, wherein the risk protection feature payout formula simulates a put option on a basket of market indices.
